(19) United States
(12) Patent Application Publication
(10) Pub. No.: US 2023/0055510 A1
(43) Pub. Date: Feb. 23, 2023

(54) SYSTEM AND METHOD FOR PROVIDING A TRANSIENT POWER ASSIST FEATURE IN A MOTOR VEHICLE

(71) Applicant: Schwarze Industries, Inc., Huntsville, AL (US)

(72) Inventor: Brian Giles, New Market, AL (US)

(21) Appl. No.: 17/718,961

(22) Filed: Apr. 12, 2022

Related U.S. Application Data
(60) Provisional application No. 63/234,690, filed on Aug. 18, 2021.

(51) Int. Cl. F02D 31/00; E01H 1/08; E01H 1/10

(52) U.S. Cl. CPC F02D 31/006; E01H 1/0818; E01H 1/0854; E01H 1/101

(57) ABSTRACT

A roadway sweeper vehicle includes one or more processors and a control console allowing the vehicle operator to select one of a plurality of available engine speeds. A power increase assist feature is available through a throttle (e.g., pedal) that provides an increased power output of the vehicle engine for a momentary or transient period of time. The additive engine speed may be calculated based on a detected position of the throttle or determined from a lookup table based on the user-selected engine speed. Related methods are also described.

### CROSS-REFERENCE TO RELATED APPLICATION

This application claims priority from and the benefit of U.S. Provisional Patent Application 63/234,690 filed Aug. 18, 2021 entitled “System and Method for Providing a Power Assist Feature in a Motor Vehicle,” by the inventor herein and in common ownership herewith, which is incorporated herein by reference.

### BACKGROUND

This section is intended to provide a background or context to the invention that is recited in the claims. The description herein may include concepts that could be pursued but are not necessarily ones that have been previously conceived or pursued. Therefore, unless otherwise indicated herein, what is described in this section is not prior art to the description and claims in this application and is not admitted to be prior art by inclusion in this section.

This patent application relates to certain types of commercial trucks classified as class 6 (GVWR 19501→26000 lbs.) or class 7 (GVWR 26001→33000 lbs.) vehicles configured as roadway or street sweepers. While commercial trucks include the usual foot-actuated throttle pedal for use in driving the truck from one location to another (including at highway speeds), street or roadway sweepers move relatively slowly while sweeping along a curb. While class 6/7 trucks are specified as optimum, trucks of a higher or lower class rating are not excluded.

Roadway or street sweepers (generally referred to herein as roadway sweepers, sweeper vehicles, or roadway sweeper vehicles) have evolved into two general sweeper-vehicle configurations.

In a first sweeper-vehicle configuration, better-suited for parking lot/garage sweeping, the vehicle engine (viz., the “prime mover”) connects through a vehicle transmission via conventional drivetrain components (e.g., drive shaft(s), “U” joints, etc.) to the rear axle for vehicle movement in a forward or rearward direction. In this first sweeper-vehicle configuration, a hydraulic pump is connected to and driven by the prime mover to provide a supply of pressurized hydraulic fluid in a hydraulic system for rotating one or more side brooms and various bidirectional cylinders and related components. Since air flow streams are useful in many debris sweeping/removal contexts, a hydraulic motor, connected to the pressurized hydraulic system, is used to drive a fan (typically, centrifugal) to provide a recirculating air-flow sufficient to move debris from the surface being swept into a debris-receiving inlet or a below-atmospheric-pressure air-flow to provide a suction effect at a suction-inlet for removing debris from the swept surface.

In a second sweeper-vehicle configuration better-suited for the removal of “packed together” debris contiguous to or adjacent to a curb, an auxiliary engine is provided and coupled to the fan to provide the desired air-flow. Typically, the second engine (the auxiliary engine) is in the horsepower range. In this second sweeper-vehicle configuration, the prime mover is normally not used to power the fan. The second engine requires fuel, lubricating oil, a cooling system, maintenance and repair, etc., resulting in an additional associated cost for the desired air-flow.

Commercial truck chassis are often sold as a “chassis cab” combination with spaced parallel, longitudinally-aligned, and rearwardly extending frame rails upon which the customer installs numerous components for a specific function, such as a street or roadway sweeper. The “chassis cab” combinations typically include an operator cab, engine/transmission and related drive-line components (e.g., drive shaft(s), “U” joints, rear axle, etc.) along with steering, braking, and lighting systems.

In the case where the final configuration is a street or roadway sweeper, various sub-assemblies specific to the street sweeping function are mounted on the truck frame rails. These sub-assemblies can include, in the case of a recirculating air-flow sweeper, a fan for producing a recirculating air-flow at one or more debris pick-up openings or, in the case of a suction type sweeper, a sub-atmospheric-pressure air-inflow at one or more suction-inlet(s) for entraining debris from the swept surface for transport via ducting to a debris-receiving hopper. Other commonly used sub-assemblies include one or more hydraulic systems for creating and delivering pressurized hydraulic fluid to various hydraulic cylinders, hydraulic motors (for driving sweeping brooms), and hydraulic actuators, etc., one or more pneumatic systems for creating and delivering pressurized air to various pneumatic cylinders, pneumatic motors, and pneumatic actuators, etc., and a program-controlled network for controlling most or all aspects of the sweeping functions via an in-cab control console.

Certain types of power-handling devices, generally referred to as hydrostatic variable power dividers (VPD), are known for connection to and for accepting the output of the vehicle engine and supplying a portion of the engine output through the drivetrain to the rear axle and another portion of the engine output to at least one auxiliary device, such as a fan input shaft and/or the various pumps of the hydraulic and pneumatic systems. In general, hydrostatic variable power dividers can save the cost of the second engine and its related on-going fuel and maintenance costs. The use of hydrostatic variable power dividers can be viewed as a third sweeper-vehicle configuration.

The power demands (viz., the “load”) placed on a sweeper vehicle engine are, in part, a function of the type of debris being swept and changes in that debris as the sweeper vehicle moves, for example, along a curb. A sweeper vehicle having side brooms and a vacuuming system in which the debris is principally dried leaves will have power demands substantially less than a sweeper vacuuming water-saturated leaves. In a similar manner, the power demands placed on the vehicle engine are increased when the vehicle moves up an inclined roadway and decreased when the vehicle moves along a declining roadway.

The issue of varying power demands on the vehicle engine is addressed by one manufacturer by installing a manually operated potentiometer mounted on the vehicle dashboard. The potentiometer is connected directly or indirectly to the engine electronic control unit (ECU). The vehicle operator can manually increase or decrease the engine RPM output as needed by adjusting the potentiometer. Thus, the vehicle operator, in response to a perceived increase in power demands (“load”), can manually rotate the potentiometer in a first direction to increase engine power RPM output, and, conversely, rotate the potentiometer in the opposite direction to decrease engine power RPM output. One issue with this arrangement is that the vehicle operator can forget to return to the decreased engine speed and thus waste fuel after the extra power is no longer needed or desired.

There are various descriptive metrics for characterizing the output power of a truck engine, including the horsepower (HP) metric and the revolutions-per-minute (RPM) metric. As used herein, the RPM metric is associated with the engine power output with increased or increasing RPM corresponding to increased or increasing power output.

### SUMMARY

In some embodiments, a roadway sweeper vehicle includes an engine, under the control of an electronic control unit (ECU), which provides its output power to a hydrostatic variable power divider which, in turn, provides power along a first pathway through the vehicle transmission (typically, a multi-speed automatic transmission) and related drivetrain components (drive shaft(s), “U” joints, etc.) to the vehicle rear axle for powering the forward and reverse motion of the vehicle. A second power pathway is provided from the hydrostatic variable power divider to a shaft connected to the vehicle fan to provide sufficient power (e.g., approximately 100 HP or more) for creating the desired debris removal airflow. If desired, the second power pathway can provide power to other devices, including one or more hydraulic pumps and/or air compressor(s) and related distribution manifold(s) for powering various motors, bi-directional cylinders, actuators, etc.

In some embodiments, the sweeper vehicle roadway-speed is controlled in one of two roadway-speed regimes. In the first roadway-speed regime (sometimes referred to herein as a travel mode), the vehicle operator uses the vehicle accelerator pedal, as provided by the vehicle manufacturer, in a conventional manner to control the vehicle speed between zero and some maximum speed (e.g., a maximum highway speed), often with the use of a speed governing device. In this configuration, the hydrostatic variable power divider is controlled to pass the engine power through the variable power divider into the vehicle automatic transmission. The automatic transmission gear ratios can then be controlled by selecting one of the transmission gear ratios, typically including LO (1st) gear, second gear (S), and drive (D).

In some embodiments, the second roadway-speed regime (sometimes referred to herein as a sweeping mode) is between zero and a maximum sweeping speed, e.g., about 20 mph, which range includes the typical 3-4 mph (approximately 5-6 km/hr) roadway speed for a sweeper vehicle when sweeping along a curb. One of the plurality of available fixed engine speeds is made available to the vehicle operator and is selected by the vehicle operator from the control console in the vehicle cab. The selected engine speed output is passed through the hydrostatic variable power divider that can also be controlled to output an RPM value most suitable for input to the vehicle automatic transmission. Since the vehicle automatic transmission has plural user-selectable gearing, typically, a LO (1st) gear, a second gear (S), and a drive gear (D), the output of the hydrostatic variable power divider can be optimized for input to the vehicle automatic transmission. Thereafter, the output of the automatic transmission is provided to the rear axle. A pairing of the hydrostatic variable power divider RPM output to the vehicle automatic transmission in LO (1st) gear could be considered an acceptable, if not an optimal or near-optimal, choice for moving the sweeper vehicle at the typical 3-4 mph (approximately 5-6 km/hr) speed for a sweeper vehicle when sweeping in its sweeping mode, e.g. along a curb.

In response to an increased load condition, the vehicle operator can request a transient or temporary increase in the power output of the engine by depressing the vehicle throttle pedal to provide the desired short-term or transient increase in engine RPM to the hydrostatic variable power divider, the vehicle transmission, and to the rear axle and thereby address the need for a temporary increase in power. Thus, the accelerator pedal provides a convenient control for a temporary boost in engine RPM output as identified by the vehicle operator while in the second roadway-speed regime. The ability of the vehicle operator to request a transient or momentary increase in the power output of the engine decreases the need for the operator to switch operating power ranges.

In some implementations of the above-described system, the various components are interconnected by an industry-standard controller area network (CAN) that includes, for example, a twisted-pair bus (CAN_{HI} and CAN_{LO}) terminated at each end by a resistor to minimize signal reflection.

Each bus-interface node (BIN) includes a transceiver connected to the twisted-pair bus, a controller, and a microprocessor for handling any computations required for that bus-interface node including digital signal processing. If desired, the CAN network can provide for data processing for one bus-interface node by another bus-interface node.

A plurality of bus-interface nodes (BINs) connect the CAN bus to various components including, for example, the electronic control unit (ECU) for the vehicle prime mover (i.e, engine), the controller for the hydrostatic variable power divider, the automatic transmission, the power takeoff (PTO) driving the vehicle fan, the hydraulically driven devices, the pneumatically driven devices, and various other components.

One benefit of the controller area network (CAN) is that an almost unlimited number of bus-interface nodes (BIN) can be connected to communicate with one another and with the various sensors and controlled devices.

Although some preferred embodiments utilize a variable power divider, the improvement can be used with sweeper vehicles that do not use a variable power divider, including configurations that use an auxiliary engine or that take power from the vehicle prime mover.

### BRIEF DESCRIPTION OF THE DRAWINGS

FIG. 1 is a partial image of an exemplary multi-switch control console of a sweeper vehicle for selecting one of a plurality of available engine RPM ranges, the plus symbol (+) indicating those engine RPM speeds (viz., 1400+, 1500+, 1600+, and 1700+ RPM) where the RPM assist or boost feature is available, and the absence of a plus symbol (+) indicating the absence of the RPM assist or boost feature (in FIG. 1, the 1600+ value has been selected).

FIG. 2 is a schematic diagram of the power managing, computational, and communication components of a sweeper vehicle in the context of a multi-node CAN network topology.

FIG. 3 is a flowchart illustrating one method in which a power assist engine speed can be calculated.

FIG. 4 is a detailed schematic view of an example bus-interface node (BIN) associated with a CAN network bus of FIG. 2.

FIG. 5 is a detailed schematic view of a pedal type controller having multiple positions including a minimum threshold position to initiate a power assist.

FIG. 6 is a representative lookup table as an optional and equivalent alternative embodiment for providing power assist.

FIG. 7 is a representative flowchart illustrating a method in which the power assist engine speed is determined from a lookup table.

### DETAILED DESCRIPTION

In the fabrication and assembly of certain types of purpose-specific trucks, such as roadway sweepers, it is a common practice to purchase a commercially available truck as a “cab chassis” combination including a cab for the vehicle operator, an engine, lighting and braking systems, drivetrain components, and spaced-apart frame rails extending rearwardly from the cab. Various assemblies are then mounted to the frame rails and interconnected to achieve the desired functionality (e.g., roadway sweeper or other vehicle type). In general, the truck is provided by the manufacturer with an engine and related drivetrain components sufficient for highway use from one location to another.

In the case of a roadway sweeper, the various assemblies and sub-assemblies that are mounted to the frame include a debris-receiving hopper, a fan for establishing an air-flow at one or more debris-receiving inlets, one or more hydraulic pumps for providing pressurized hydraulic fluid via a controllable fluid manifold for distribution of the pressurized hydraulic fluid to various motors, bi-directional cylinders, actuators, etc. and (if desired) at least one pneumatic air compressor for providing pressurized air to various motors, bi-directional cylinders, and actuators for driving and controlling side brooms and/or tube brooms and the like.

In general, the vehicles provided by the manufacturer include a conventional foot-operated pedal for controlling the vehicle speed (including highway speeds) of the “as delivered” cab-chassis vehicle. The pedal assemblage includes a pedal position sensor, which preferably can take the form of a digital encoder or, alternatively, an analog device that outputs to an analog-to-digital converter to provide a digital signal that indicates the pedal position with acceptable accuracy. In general, the pedal position sensor is connected to a vehicle network to provide the pedal position information to any device that requires the information.

Because roadway sweepers usually operate at comparatively low forward speeds between zero and 20 mph, which speed range includes the 3-4 mph (approximately 5-6 km/hr) vehicle speed while sweeping along a curb with varying “load” demands, a control console is provided that presents the vehicle operator with plural operator-selectable speeds. The manufacturer supplied vehicle still controls vehicle ground speed in concert with the inputs to the hydrostatic variable power divider and any RPM “assist” or “boost,” as explained below.

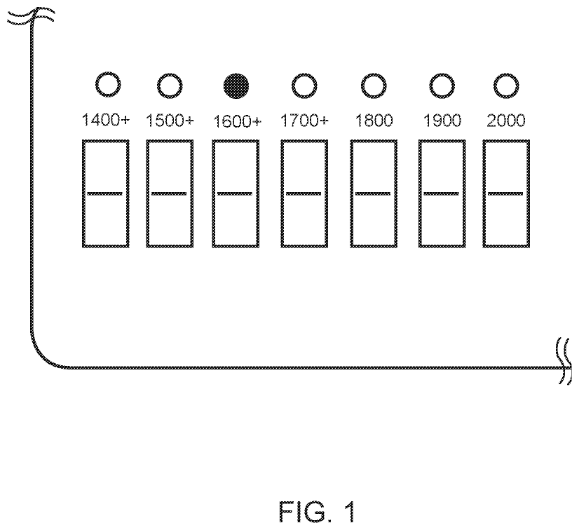

Shown in FIG. 1 is one example of a speed selection control console available to the vehicle operator for selecting one of the available RPM values in view of prior operator experience with the particular sweeping route. As shown, seven side-by-side rocker-style switches provide seven possible operator-selectable RPM values including 1400 RPM, 1500 RPM, 1600 RPM, 1700 RPM, 1800 RPM, 1900 RPM, and 2000 RPM. In FIG. 1, the plus symbol (+) suffix indicates that the selected engine speed (1400+, 1500+, 1600+, 1700+ RPM) includes an available RPM “assist” or “boost” option. As can be appreciated, more or fewer engine speed selections can be provided with the RPM assist feature. While FIG. 1 illustrates plural rocker-style switches available to the vehicle operator, other arrangements are suitable, including user-accessible touch pads for selecting control features by the vehicle operator.

As explained below, the RPM assist feature is actuated by the vehicle operator by depressing the vehicle accelerator pedal P to and/or beyond a “threshold assist” position, typically about 50% or so of the available pedal travel range, to initially provide the computed engine assist value. Further pedal depression beyond the threshold assist position will increase the RPM assist until a maximum assist value is attained.

In FIG. 1, only the first four selections (1400+, 1500+, 1600+, 1700+) have been provided with the assist (+) feature; as can be appreciated more or fewer engine speed selections can be provided with the RPM assist feature.

An RPM value, when selected, will maintain a desired forward vehicle speed for a particular sweeping “load.” For example, if dry leaves are being swept, the vehicle operator may select the 1400+ RPM speed; if damp leaves are being swept, the operator may select the 1500+ RPM speed; and, if water-saturated leaves are being swept, the operator may select the 1600+ RPM speed.

In addition to variations in sweeping “load” consequent to changes in the material being swept, changes in the inclination or declination of the roadway being swept can likewise affect the sweeping “load.”

Because of the variations in load, it is considered beneficial for the vehicle operator to have the ability to temporarily or momentarily increase engine RPM (i.e., power) output on an as-needed basis. As explained in more detail below, for any selected RPM value that has the associated RPM “assist” or “boost” feature (as indicated by the “+” symbol), the system determines the available “assist” power for the selected RPM speed as a percentage of the selected RPM value. The “assist” feature can be invoked by depressing the vehicle throttle pedal a selected threshold distance (e.g., about 50% of the available pedal travel distance), with further depression of the pedal increasing the available boost power until the boost power achieves its maximum value. As can be appreciated, different pedal depression percentages (e.g., 40%, 60%) can be used to invoke the assist feature.

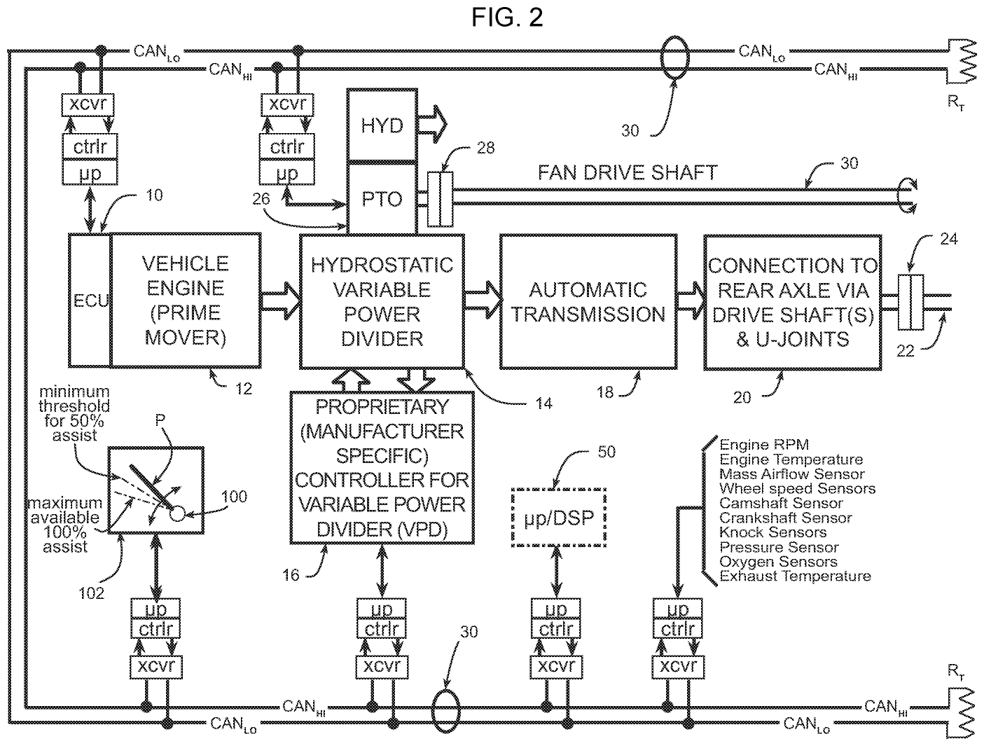

FIG. 2 is a schematic diagram of an exemplary mechanical drive system and related controller area network (CAN) suitable for use as part of a roadway sweeper. As shown, a conventional twisted-pair bus includes CAN_{HI} and CAN_{LO} signal paths. An electrical control unit (ECU) accepts as inputs the user-selected RPM value from FIG. 1 and the output of various sensors for monitoring and controlling the vehicle engine 12. The mechanical power output of the vehicle engine 12 is connected to a hydrostatic variable power divider 14 which accepts control information from a manufacturer-specific proprietary controller 16. A suitable hydrostatic variable power divider 14 and its controller 16 (Hydromech VPD 2500) are available from the Marmon-Herrington Corp., Louisville, Ky 40223.

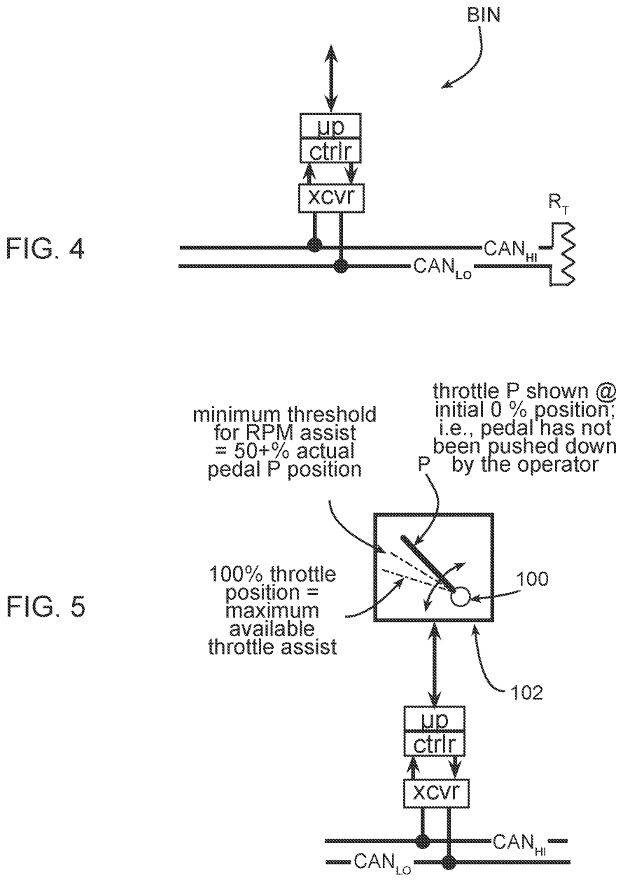

As shown in FIGS. 2 and 4, each bus-interface node BIN includes a bi-directional transceiver XCVR that connects to the twisted-pair network bus (CAN_{LO} and CAN_{HI}). A controller CTRLR interfaces between its associated transceiver XCVR and a microprocessor pp. The microprocessor pp functions to address processing needs, including arithmetic and digital signal processing (DSP) operations. Each bus-interface node BIN can communicate with any other device on the network. In general, the CAN network conforms to one or more of the ISO 11898-1, ISO 11898-2 and/or ISO 11898-3 standards.

Each bus-interface node BIN includes a microprocessor pp for addressing computational needs for that bus interface-node BIN. On occasion, a need may arise for a separate, more capable, microprocessor for more complex or more extensive processing, including more extensive digital signal processing. A more capable bus-interface node BIN can be provided, represented at 50 in FIG. 2. The CAN system communicates through each bus interface node using data-containing frames (i.e., packets with addresses and IDs). Although multiple microprocessors are shown, in some embodiments a single processor may be in communication with all of the system components and configured for controlling them. As used herein, a processor may be any suitable programmable machine capable of executing machine-readable instructions.

A standard manufacturer-supplied foot-actuated pedal 100 (FIG. 5) is provided for use by the vehicle operator in one of two modes or regimes: a conventional first travel mode or regime for use in driving the vehicle from one place to another (including at highway speeds) and a second curb-sweeping mode or regime between zero and 20 MPH which includes the typical 3-4 mph speed (approximately 5-6 km/hr) for sweeping along curbs and gutters.

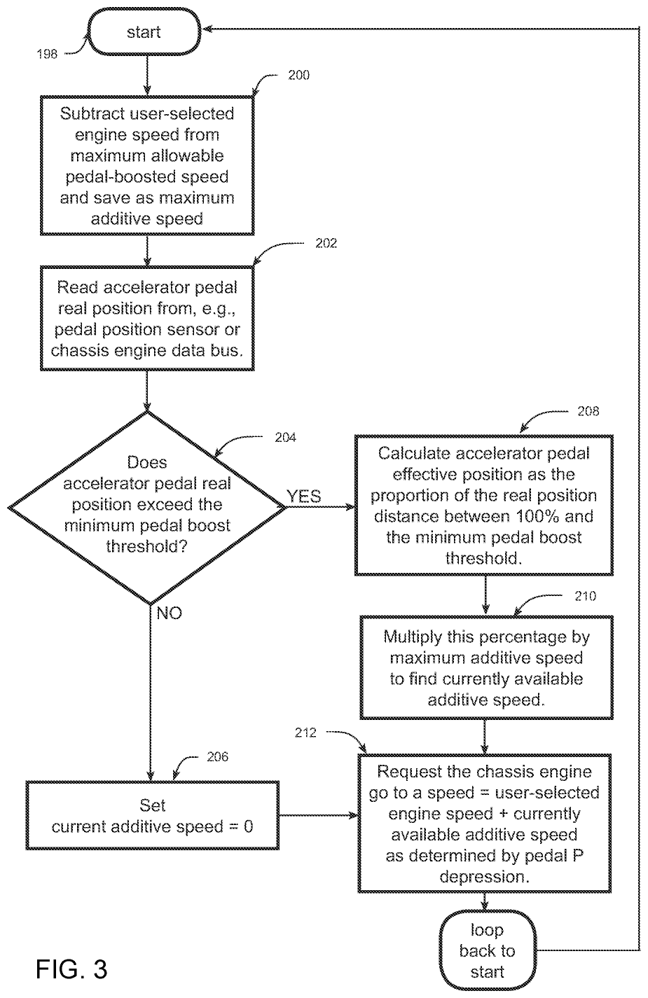

The manufacturer-supplied foot-actuated pedal 100 typically includes a digital sensor 102, whose output is representative of the pedal position. Thus, when the vehicle operator senses a temporary need for more power in the curb-sweeping mode (often necessitated by an increased density of the debris being swept or a change in the roadway inclination/declination), the vehicle operator can press on the pedal P to or beyond some assist threshold to signal the electronic control unit 10 to temporarily increase engine RPM and associated power output within selected limits for each selected power range in a manner consistent with the representative flow chart of FIG. 3.

FIG. 3 illustrates one suitable flowchart for computing an available power assist or boost. Once the sequence is started at 198, and as shown at 200, the operator-selected engine speed having the associated power boost or assist feature (1400+, 1500+, 1600+, 1700+ RPM) is subtracted from an arbitrary higher available engine speed (e.g., 1800 RPM) and saved as a maximum available additive speed value. For example, if the operator selects 1600 RPM (as shown in FIG. 1), that value is subtracted from the 1800 RPM engine speed to provide a maximum additional 200 RPM available for a power additive boost, as presented in execution step 200, as follows:

### Step 200

User-Selected Engine Speed=1600 rpm (FIG. 1)
Maximum Allowable Pedal-Boost Speed: 1800-1600 RPM=200 RPM
Maximum Available Additive Speed=1800−1600=200 RPM

As can be appreciated, the 1800 RPM value is arbitrary and other values may be selected.

Thereafter, at execution step 202, the accelerator pedal position is determined from the chassis engine data bus (optionally) or the pedal position sensor 102 (FIG. 5). As shown at step 204, a query is presented to determine if the pedal P position has exceeded a minimum threshold (preset to be 50% in the preferred embodiment); if NO, the current additive speed is set to zero at step 206. If YES, the accelerator pedal position is calculated arithmetically at steps 208/210 as a percentage of the difference between 100% and the minimum threshold, as shown by example, as follows:

### Step 208

Minimum Pedal Boost Threshold: 50%
Accelerator Pedal Real Position: 72%
Accelerator Pedal Effective Position: =(72-50)/(100-50)=0.44=44%

At step 210, the current available additive speed is calculated arithmetically as follows:

### Step 210

Current Available Additive Speed: 44% of 200=88 RPM
Final Requested Engine Speed: 1600+88=1688 RPM
Thereafter, the processing path loops back to START with the process repeating in a feedback control loop.

The above-described system allows the vehicle operator to initially establish a selected one of a plurality of possible engine RPM values; thereafter, as the vehicle encounters changes in the “load,” the vehicle operator can request a temporary or transient additive “boost” or “assist” by merely depressing the vehicle accelerator pedal P and thereafter (when the need for a boost or assist is no longer required) releasing the vehicle pedal P back to a desired level.

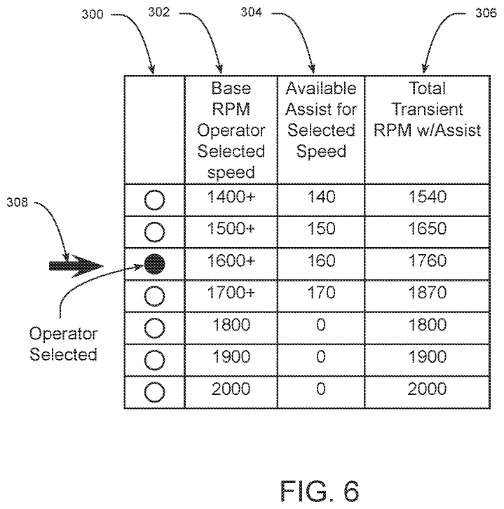

The arrangement of FIG. 3 is dependent upon a calculated (i.e., computational) value. If desired, an alternative arrangement can be provided via a lookup table. A lookup table is an array that replaces runtime computation with an array indexing operation. One representative array is shown in FIG. 6, which shows a multi-column/row table. The first column 300 shows a plurality of indicia to which a pointer (index indicator) 308 denotes the 1600+ operator-selected base RPM in column 302. Column 304 shows the available RPM assist or boost for each possible operator selection; in the case of FIG. 6, the available assist for each selected base RPM (having the available assist or boost feature as indicated by the + suffix) is 10/of the operator selected base RPM. As can be appreciated, other percentage values can be used, including different percentages for each of the operator selectable speeds. Column 306 shows the respective total transient RPM (base RPM plus assist).

In practice, each operator-selectable RPM value (via column 300) has an associated memory cell for providing the corresponding command to the engine ECU 10 (FIG. 2) directly or indirectly (via the CAN network) to command the engine 12 to the selected engine RPM value.

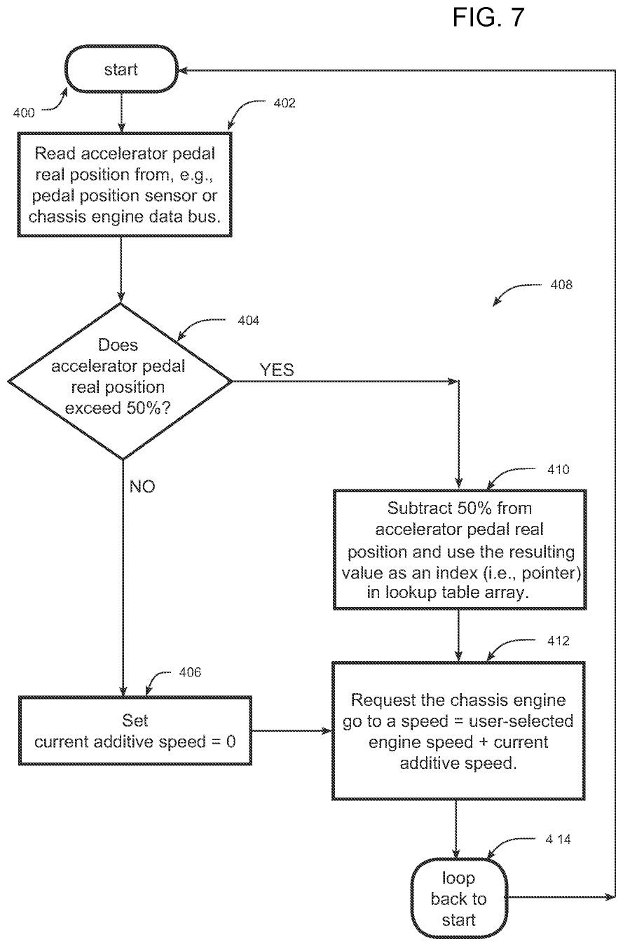

FIG. 7 is a flowchart, similar to FIG. 3, illustrating a suitable command flow for use with a lookup table. Once the process is started at step 400, the real position of the accelerator pedal is determined from the engine data bus or the pedal position indicator at step 402. Thereafter, at step 404, a query is presented as to whether or not the accelerator pedal exceeds the 50% position. If the pedal does not exceed the 50% position, the current additive speed is set to zero at step 406. Conversely, if the real pedal position exceeds 50%, as shown at step 410, 50% is subtracted from the real pedal position and the resulting value is used as a pointer in a lookup table to determine the additive speed. At step 412, the engine receives a request to go to a speed equal to the user-selected engine speed plus the additive speed.

While the illustrated embodiments, disclosed above, utilize a hydrostatic variable power divider, the power assist or boost feature can be used in the context of a dual engine sweeper vehicle. More specifically, a roadway or street sweeper vehicle can include a manufacturer-provided engine that transmits power to the rear wheels for forward and reverse motion and include a secondary engine for driving the suction-creating fan and, if desired, one or more auxiliary devices including, e.g., hydraulic pump(s) and/or air compressors for providing pressurized fluids/air for various fluidic motors and actuators.

The electronic processing herein is disclosed as a mix of analog devices and digital devices; both processing regimes are equally suitable.

As will be apparent to those skilled in the art, various changes and modifications may be made to the illustrated embodiments without departing from the spirit and scope of the invention as determined by the appended claims and their legal equivalents.

What is claimed is:

1. A roadway sweeper vehicle of the type having an engine with an associated system for control thereof, the engine operable at a plurality of operator-selectable engine speeds and connected to at least one hydrostatic variable power divider to provide power through a first pathway and a second pathway, the first pathway providing power through a vehicle transmission and drivetrain components to an axle for propelling the vehicle in at least a forward direction and the second pathway providing power to at least one driven device, the sweeper vehicle comprising:
a processor configured for receiving an indication of an operator-selected engine speed and determining an available boost speed;
an operator-controllable throttle having a sensor for detecting a throttle position;
said processor configured for determining whether the throttle position exceeds a minimum threshold and increasing the engine speed to be approximately equal to the sum of the operator-selected engine speed and the available boost speed if the throttle position exceeds the minimum threshold.

2. The roadway sweeper vehicle of claim 1, wherein said at least one driven device comprises a fan for creating a debris in-flow at a debris inlet.

3. The roadway sweeper vehicle of claim 1, wherein said at least one driven device comprises a fan for creating a below atmospheric pressure in-flow at a debris inlet.

4. The roadway sweeper vehicle of claim 1, wherein said at least one driven device is selected from the group consisting of:
a hydraulic pump for creating a source of pressurized hydraulic fluid,
an air compressor for creating a source of pressurized air, and
a combination thereof.

5. The roadway sweeper vehicle of claim 4, wherein said at least one driven device further comprises a rotatable broom operable for sweeping debris toward a debris inlet.

6. The roadway sweeper vehicle of claim 1, wherein said throttle comprises a foot-actuated throttle pedal.

7. The roadway sweeper vehicle of claim 1, wherein said vehicle has a travel mode and a sweeping mode and said processor is further configured for executing said determining and said increasing only if the sweeping mode is selected.

8. A method for controlling a roadway sweeper vehicle of the type having an engine operable at a plurality of different preset engine speeds and connected to a hydrostatic variable power divider to provide power to first and second pathways, the first pathway through a vehicle transmission and drivetrain components to provide power to an axle for propelling the vehicle in a forward or reverse direction, and the second pathway to a driven device, the method comprising:
providing an operator-controllable throttle operable between an initial position, a minimum threshold position, and a maximum position and having a sensor for detecting a throttle position;
subtracting a user-selected engine speed from a second engine speed greater than the user-selected engine speed to determine a maximum additive speed value;
determining whether the throttle position exceeds the minimum threshold position, and if so, calculating a proportion of the throttle position with respect to the difference between the maximum position and the minimum threshold position;
determining a current additive speed value by multiplying the proportion by the maximum additive speed value; and
maintaining an engine speed approximately equal to the sum of the user-selected engine speed and the current additive speed value for a period of time.

9. The method of claim 8, wherein the method is executed by a processor including a feedback control loop.

10. The method of claim 8, wherein said vehicle comprises a travel mode and a sweeping mode, and wherein said maintaining is performed only in said sweeping mode.

11. A method for controlling a roadway sweeper vehicle having an engine, a throttle operably engaged with the engine, a sensor configured for detecting a throttle position of the throttle, and a processor in communication with the engine, the throttle, and the sensor, the method comprising:
establishing a user-selected engine speed;
detecting a throttle position of the throttle;
if the throttle position exceeds a minimum threshold position, determining an additive speed value; and
maintaining an engine speed substantially equal to the sum of the user-selected engine speed and the additive speed value for a period of time.

12. The method of claim 11 wherein the determining comprises:
calculating a maximum allowable additive speed based on the user-selected engine speed;
calculating an amount by which the throttle position exceeds the minimum threshold position as a percentage of the difference between a maximum throttle position and the minimum threshold position; and
calculating the additive speed value as the product of the maximum allowable additive speed multiplied by the percentage.

13. The method of claim 11 wherein the determining comprises determining the additive speed value from a lookup table based on the user-selected engine speed.

14. A roadway sweeper vehicle of the type having a first engine with an associated system for control thereof, the first engine connected to provide power through a first pathway comprising a vehicle transmission and drivetrain components to an axle for propelling the vehicle in at least a forward direction, and a second engine to provide power to at least one driven device, the sweeper vehicle comprising:
a processor configured for receiving an indication of a user-selected engine speed and determining an available boost speed; and
an operator-controllable throttle having a sensor for detecting a throttle position;
said processor further configured for determining whether the throttle position exceeds a minimum threshold, and if the throttle position exceeds the minimum threshold, increasing the engine speed to be approximately equal to the sum of the user-selected engine speed and the available boost speed.
